(19) United States
(12) Patent Application Publication
(10) Pub. No.: US 2010/0185341 A1
(43) Pub. Date: Jul. 22, 2010

(54) VEHICLE MODE ACTIVATION BY GESTURE RECOGNITION

(75) Inventors: THOMAS A. WILSON, ROCHESTER HILLS, MI (US); CRAIG A. KOLLAR, STERLING HEIGHTS, MI (US); TIMOTHY J. HERRICK, ROCHESTER HILLS, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/354,999

(22) Filed: Jan. 16, 2009

(51) Int. Cl. G06F 19/00

(52) U.S. Cl. 701/1

(57) ABSTRACT

Methods and devices are provided for activation of a vehicle operational mode. The device includes one or more detectors and a controller. The one or more detectors visually monitor one or more predetermined spatial locations, each of the one or more detectors corresponding to one of the one or more predetermined spatial locations. The controller is coupled to the one or more detectors and activates a predetermined vehicle operational mode in response to a current vehicle operational mode and a predetermined gesture detected within one of the one or more predetermined spatial locations.

### TECHNICAL FIELD

The present invention generally relates to spatial and time-based or non time-based gesture recognition, and more particularly relates to a method and apparatus for activating various vehicle modes in response to gesture recognition.

### BACKGROUND OF THE INVENTION

Conventional key fobs have been provided for user activation of various vehicle modes such as car lock or unlock, trunk open, and/or car panic mode (activation of the car horn and the car lights to create a visual and audio alarm for theft or personal attack deterrence) remote from the vehicle. However, many times the user may have his or her hands full and it may be difficult to activate buttons on the key fob. Also, the number of activatable vehicle modes is limited by the number of buttons that can be fit on an ergonomically-sized key fob. Furthermore, some vehicle modes, such as some theft detection and deterrent modes, are typically limited by requirements of either car contact or user activation.

Gesture recognition technology has been developed for data collection and typically includes either or both of time based gesture recognition and spatial gesture recognition. Time based gesture recognition detects movement and recognizes a predetermined gesture in response to the movement. Spatial gesture recognition detects an item at a predetermined location or a predetermined item within a predetermined spatial location. While gesture recognition technology has recently improved, the application of gesture recognition technology to vehicle operation remains primitive or non-existent.

Accordingly, it is desirable to provide a method and apparatus for activation of various vehicle modes in response to gesture recognition. In addition, other desirable features and characteristics of the present invention will become apparent from the subsequent detailed description and the appended claims, taken in conjunction with the accompanying drawings and the foregoing technical field and background.

### SUMMARY OF THE INVENTION

A method is provided for activation of a vehicle operational mode. The method includes the step of visually monitoring one or more predetermined spatial locations and detecting a predetermined gesture within one of the one or more predetermined spatial locations. The method further includes the step of activating a predetermined vehicle operational mode in response to the predetermined gesture and a current vehicle operational mode.

A device is provided for activation of an operational mode. The device includes one or more detectors and a controller. The one or more detectors visually monitor one or more predetermined spatial locations, each of the one or more detectors corresponding to one of the one or more predetermined spatial locations. The controller is coupled to the one or more detectors and activates a predetermined operational mode in response to a current operational mode and a predetermined gesture detected within one of the one or more predetermined spatial locations.

A vehicle is also provided. The vehicle includes one or more detectors, one or more operational mode actuators, and a controller. The one or more detectors visually monitor one or more predetermined spatial locations interior to the vehicle and adjacent to an exterior of the vehicle, each of the one or more detectors corresponding to one of the one or more predetermined spatial locations. The one or more operational mode actuators activate a vehicle operational mode. The controller is coupled to the one or more detectors and the one or more operational mode actuators and generates an activation signal in response to the current operational mode and a predetermined gesture detected by one of the one or more detectors. The controller provides the activation signal to at least one of the one or more operational mode actuators, the at least one of the one or more operational mode actuators selected by the controller in response to the current operational mode, the predetermined gesture, and the one of the one or more predetermined spatial locations in which the predetermined gesture is detected.

### DESCRIPTION OF THE DRAWINGS

The present invention will hereinafter be described in conjunction with the following drawing figures, wherein like numerals denote like elements, and

FIG. 1, including FIGS. 1A and 1B, illustrates a left rear bottom perspective view of a vehicle operating in accordance with an embodiment of the present invention;

FIG. 2 illustrates a block diagram of components of the vehicle of FIG. 1 in accordance with the embodiment of the present invention;

FIG. 3 illustrates a flowchart of a first vehicle mode activation operation in accordance with the embodiment of the present invention;

FIG. 4, including FIGS. 4A, 4B and 4C, illustrates a set of interior vehicle time based gestures of the first vehicle mode activation operation in accordance with the embodiment of the present invention;

FIG. 5, including FIGS. 5A and 5B, illustrates a first set of interior predetermined gestures of the first vehicle mode activation operation in accordance with the embodiment of the present invention;

FIG. 6, including FIGS. 6A and 6B, illustrates a second set of interior predetermined gestures of the first vehicle mode activation operation in accordance with the embodiment of the present invention;

FIG. 7, including FIGS. 7A, 7B, 7C and 7D, illustrates a first set of exterior time based gestures of the first vehicle mode activation operation in accordance with the embodiment of the present invention;

FIG. 8, including FIGS. 8A and 8B, illustrates a second set of exterior time based gestures of the first vehicle mode activation operation in accordance with the embodiment of the present invention;

FIG. 9, including FIGS. 9A, 9B and 9C, illustrates a set of predetermined items identifiable as exterior predetermined gestures of the first vehicle mode activation operation in accordance with the embodiment of the present invention;

FIG. 10, including FIGS. 10A and 10B, illustrates a set of exterior predetermined gestures of the first vehicle mode activation operation in accordance with the embodiment of the present invention;

FIG. 11 illustrates a predetermined text device utilized for the first vehicle mode activation operation in accordance with the embodiment of the present invention;

FIG. 12 illustrates a vehicle authenticated device utilized for the first vehicle mode activation operation in accordance with the embodiment of the present invention;

FIG. 13 illustrates a flowchart of an authentication operation in accordance with the embodiment of the present invention;

FIG. 14 illustrates a flowchart of a second vehicle mode activation operation in accordance with the embodiment of the present invention; and

FIG. 15, including FIGS. 15A and 15B, illustrates a set of spatial gestures of the third vehicle mode activation operation in accordance with the embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

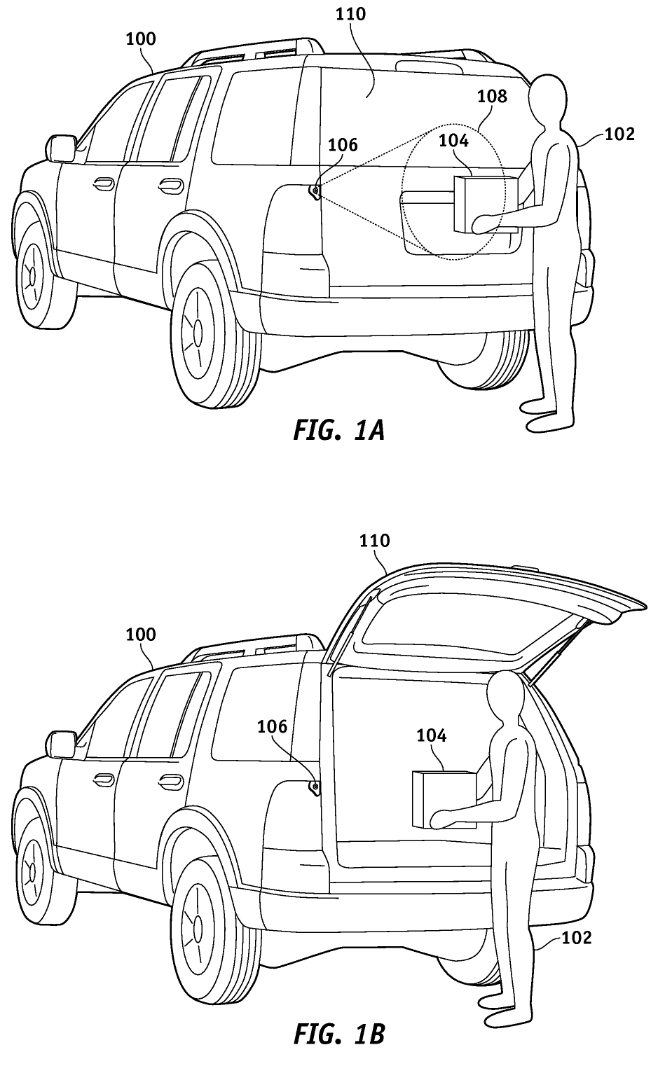

Referring to FIG. 1, including FIGS. 1A and 1B, a vehicle 100 in accordance with an embodiment of the present invention includes gesture recognition capability to enable activation of vehicle operational modes. For example, in FIG. 1A, a person 102 approaches the rear of the vehicle 100 with a large item 104, such as a box, in his/her hands. A detector 106 located above the left taillight and within the taillight lens visually monitors a predetermined spatial location 108 adjacent to the exterior of the vehicle 100. While the detector 106 is depicted in FIGS. 1A and 1B as located within the left taillight lens, such location is exemplary only and not essential for operation in accordance with the present embodiment. It is merely necessary that the detector 106 has an unrestricted view of a predetermined spatial location 108.

After the vehicle 100 is unsecured, such as unlocking the vehicle 100 by use of a remote keyless entry device on a key fob, and as the person 102 approaches the rear of the vehicle 100, a current vehicle operational mode has the horizontally-hinged lift gate 110 in a closed position as shown in FIG. 1A. When the detector 106 detects the large item 104 within the predetermined spatial location 108, the vehicle 100 activates a vehicle operational mode to open the lift gate 110 as shown in FIG. 1B, thereby facilitating loading of the large item 104 into the vehicle 100.

Instead of the large item 104 triggering the vehicle operational mode to open the lift gate 110, the vehicle 100 may activate the vehicle operational mode in response to hands of the person 102 being placed at a predetermined position within the spatial location 108. Alternately, the vehicle 100 may activate the vehicle operational mode in response to recognition of a vehicle authenticated device, such as an authenticated key fob or cellular phone being sited at a predetermined position within the spatial location 108.

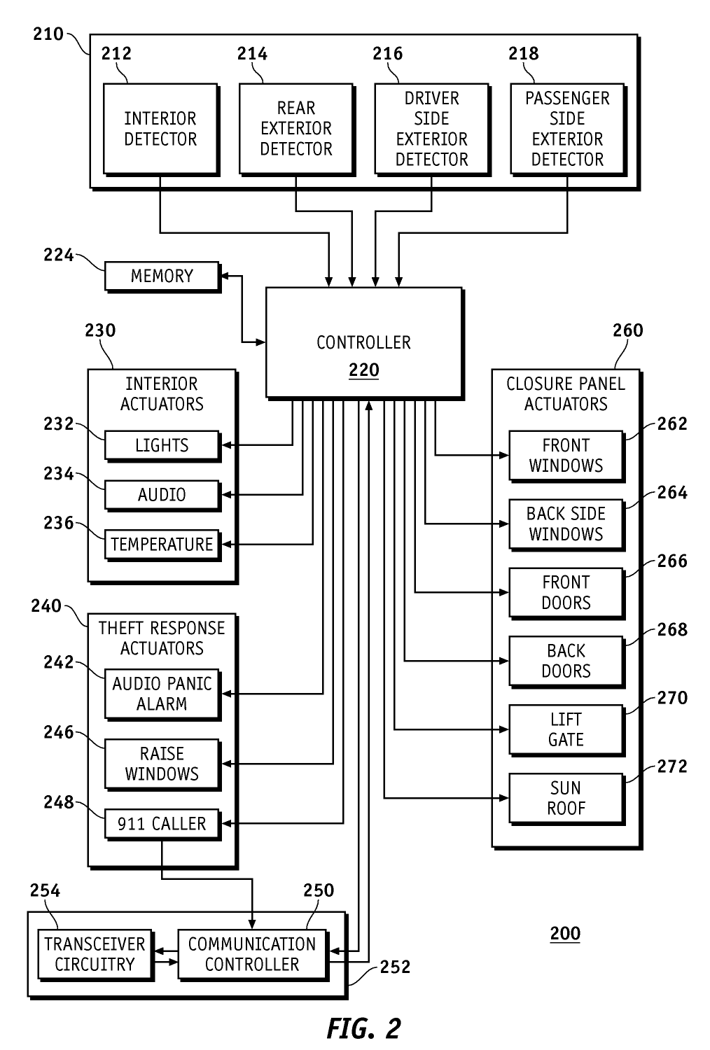

Referring to FIG. 2, a block diagram 200 depicts components of the vehicle 100 utilized to enable activation of vehicle operational modes in accordance with the present embodiment. Detectors 210 include one or more detectors 212, 214, 216, 218 which visually monitor predetermined spatial locations interior to or adjacent to an exterior of the vehicle 100.

Detector 212, which may be a single detector or multiple detectors, monitors the interior of the vehicle 100. In a similar manner, detector(s) 214 monitor one or more predetermined spatial location(s) adjacent to the rear exterior of the vehicle 100 including, for example, detector 106 (FIG. 1A). Detector(s) 216 monitor one or more predetermined spatial location(s) adjacent to a driver's side exterior of the vehicle 100, and detector(s) 218 monitor one or more predetermined spatial location(s) adjacent to a passenger's side exterior of the vehicle 100.

The detectors 212, 214, 216, 218 are coupled to a controller 220 for providing signals thereto. The controller 220 is coupled to a memory 224 for storing information therein and retrieving information therefrom for operation in accordance with the present embodiment. For example, a device such as a cellular telephone or a key fob can be authenticated as described hereinbelow and information required for recognition of the vehicle authenticated device is stored in the memory 224 for retrieval by the controller 220 when determining whether a vehicle authenticated device is detected.

The controller 220 is also coupled to operational mode actuators 230, 240, 260 for activating vehicle operational modes. The controller 220 generates activation signals in response a current operational mode of the controller 220 and a predetermined gesture determined from the information provided by the detectors 212, 214, 216, 218 to the controller 220. The controller 220 then provides the activation signals to selected ones of the operational mode actuators 230, 240, 260. The operational mode actuators 230, 240, 260 are selected by the controller 220 in response to the current operational mode of the controller 220, the predetermined gesture, and a predetermined spatial location in which one of the detectors 212, 214, 216, 218 identifies the predetermined gesture. For example, if the predetermined gesture is identified by the interior detector 212, the controller 220 provides an activation signal to one of vehicle interior actuators 230.

The vehicle interior actuators 230 include an interior lighting actuator 232, an interior audio volume actuator 234 and an interior temperature control actuator 236. The controller 220 provides activation signals to the vehicle interior actuators 230 to manipulate an attribute of vehicle interior operational modes. For instance, the interior lighting actuator 232 manipulates an interior light brightness and the interior audio volume actuator 234 manipulates an audio system volume. When the engine is running, the interior temperature control actuator 236 manipulates a vehicle interior temperature control device to increase or decrease either the heat or air conditioning provided to the interior of the vehicle 100.

Vehicle theft deterrent actuators 240 include an audio panic alarm actuator 242, a vehicle window raising actuator 246, and an emergency service provider (e.g., 911) calling actuator 248. When the controller 220 determines that one of the detectors 210 detects a threatening gesture in accordance with the present embodiment, the controller 220 activates a theft deterrent response mode including one or more theft deterrent actions by providing activation signals to one or more of the actuators 242, 246, 248. An activation signal provided to the audio panic alarm actuator 242 activates a loud audio alarm including activating a horn of the vehicle 100. An activation signal provided to the vehicle window raising actuator 246 automatically raises the windows of the vehicle 100. And an activation signal provided to the emergency service provider calling actuator 248 supplies appropriate signals to a communication controller 250 of a wireless communication device 252 (e.g., an OnStar® device) for initiating a 911 call to an emergency service provider such as the police via transceiver circuitry 254.

Vehicle closure panel actuators 260 are coupled to vehicle closure panels such as doors (including sliding and swinging doors), windows (including vertically-hinged and horizontally hinged liftglass), drop gates and liftgates, sunroofs, and folding tops and power tonnaeau covers. For example, a sports utility vehicle such as vehicle 100 (FIG. 1A) may include vehicle closure panel actuators 260 such as front side window actuators 262, back side window actuators 264, front door actuators 266, back door actuators 268, lift gate actuators 270, and, possibly, sunroof actuators 274.

The controller 220 generates a vehicle closure panel activation signal in response to detection of a predetermined gesture and a current vehicle operational mode. For example, when the current vehicle operational mode has vehicle closure panels in a closed position, detection of a predetermined gesture could cause the controller 220 to provide a vehicle closure panel open signal to one or more of the actuators 262, 264, 266, 268, 270, 272. In a similar manner, when the current vehicle operational mode has vehicle closure panels in an open position, detection of a predetermined gesture could cause the controller 220 to provide a vehicle closure panel close signal to one or more of the actuators 262, 264, 266, 268, 270, 272. If a predetermined stop gesture is detected by the controller 220 while the current vehicle mode is either opening or closing one or more vehicle closure panels, the controller 220 generates a vehicle closure panel stop signal and forwards it to the appropriate one(s) of the actuators 262, 264, 266, 268, 270, 272.

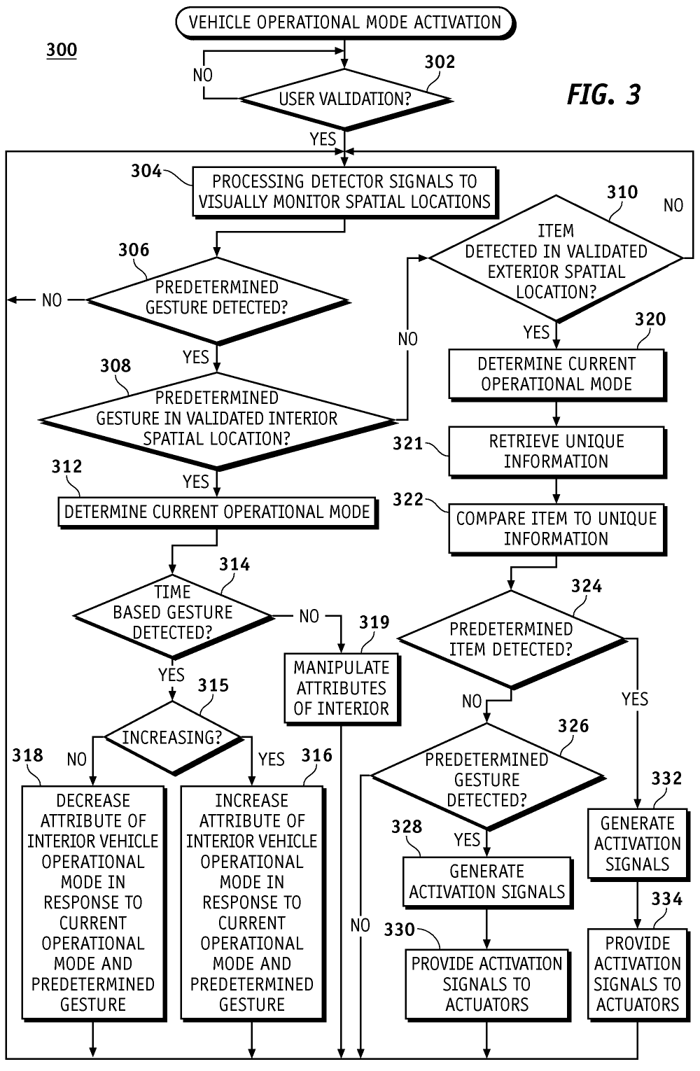

Referring to FIG. 3, a flowchart 300 illustrates a first vehicle mode activation operation of the controller 220 in accordance with the embodiment of the present invention. Initially, the controller 220 awaits determination of a user validation 302 for initiation of the vehicle operational mode activation process. A user validation could be a user key press on a key fob to unsecure or unlock the vehicle 100 or a vehicle operation such as locking or unlocking the doors. In accordance with present embodiment, a user validation could also be passively accomplished by a smart key fob as a user approaches the vehicle 100 in a manner well-known to those skilled in the art. Further, the user could select a validation scheme that would validate use of specific interior vehicle detectors for one or more interior functions in response to gestures in one or more validated interior spatial locations and selected exterior detectors in one or more validated exterior spatial locations for only validated functions (e.g., side detectors 216, 218 for only theft deterrent functions) when the car is moving and validate use of exterior detectors in one or more validated exterior spatial locations for a plurality of exterior functions (and possibly interior detectors in one or more validated interior spatial locations for one or more interior functions) when the vehicle is stopped.

When user validation 302 has been received, the controller 220 processes 304 signals received from the one or more of the detectors 212, 214, 216, 218 in order to visually monitor the predetermined spatial locations covered by the one or more of the detectors 212, 214, 216, 218. When a predetermined gesture is detected 306, the controller 220 determines whether the predetermined gesture is in a validated interior spatial location 308 interior to the vehicle or an exterior validated spatial location 310 adjacent to an exterior of the vehicle.

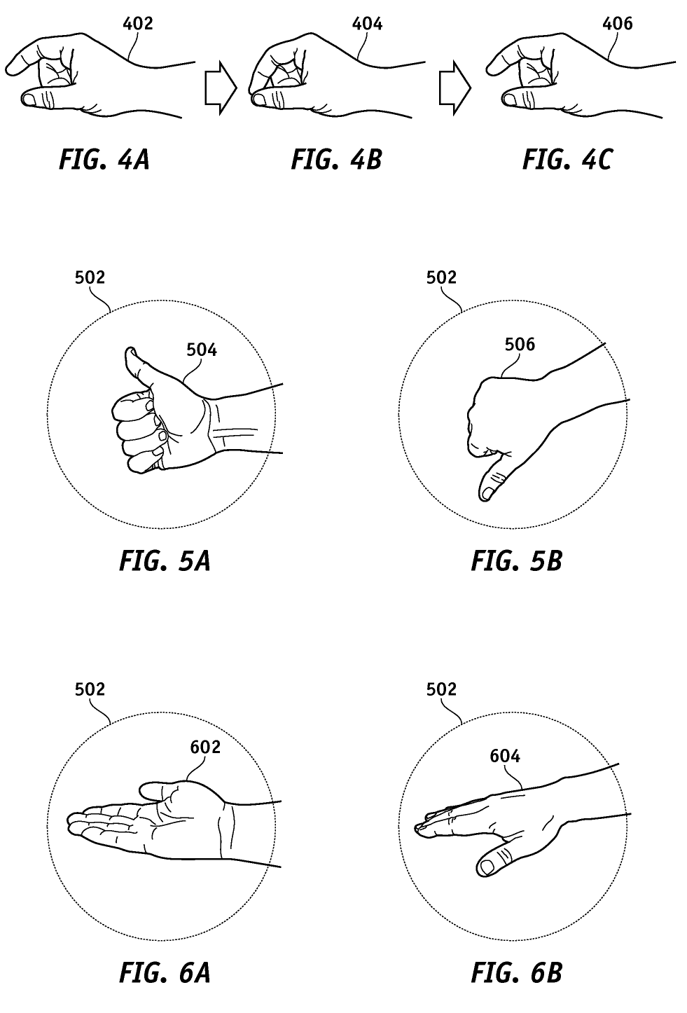

When the predetermined gesture is detected in a validated interior spatial location 308, the controller 220 determines the current operational mode 312. For example, the controller 220 determines whether the engine is running, whether an audio device is active, whether interior lighting is turned on, and whether heating or air conditioning is turned on. In accordance with the present embodiment, attributes of interior vehicle operational modes may be controlled by time based gestures. FIG. 4, including FIGS. 4A, 4B and 4C, depicts a time based gesture in accordance with the present embodiment. To control an interior vehicle operational mode, a vehicle driver or passenger may place the fingers of one hand near one of the interior detectors and move his index finger and thumb from a position 402 in FIG. 4A to a position 404 in FIG. 4B and back to a position 406 to “click” the index finger and thumb in a timed based gesture to indicate manipulating the attribute of the interior vehicle operational mode by turning on or turning off an interior function control device (e.g., turning on a predetermined audio system, the interior lighting, or an interior temperature control system such as an air conditioner).

Referring back to FIG. 3, if the predetermined gesture is determined to be a predetermined time based gesture 314 such as that depicted in FIGS. 4A, 4B and 4C, the controller 220 determines whether the time based gesture indicates increasing the attribute of the interior vehicle operational mode 315, where increasing the attribute of the interior vehicle operational mode also includes turning on an interior function control device. If the time based gesture indicates increasing the attribute of the interior vehicle operational mode 315, the controller generates activation signals in response to the current operational mode and the predetermined time based gesture and provides the activation signals to appropriate ones of the interior actuators 232, 234, 236 to increase 316 the attributes of the interior vehicle operational mode. If the time based gesture does not indicate increasing the attribute of the interior vehicle operational mode 315, the controller generates activation signals in response to the current operational mode and the predetermined time based gesture and provides the activation signals to appropriate ones of the interior actuators 232, 234, 236 to decrease the attributes of the interior vehicle operational mode 318, where decreasing the attribute of the interior vehicle operational mode also includes turning off an interior function control device.

When the predetermined gesture in the interior spatial location is determined not to be a time based gesture 314, the controller 220 generates activations signals to manipulate the attributes of the interior vehicle operational mode in response to the current operational mode and the predetermined gesture 319. Referring to FIG. 5, including FIGS. 5A and 5B and FIG. 6, including FIGS. 6A and 6B, attributes of the interior vehicle operational mode can be increased or decreased in response to a predetermined gesture at a predetermined spatial location 502. For example, the attribute of the interior vehicle operational mode can be increased in response to the predetermined gesture 504 within the interior spatial location 502 as depicted in FIG. 5A or the predetermined gesture 602 within the interior spatial location 502 as depicted in FIG. 6A, either of which indicates increasing the attribute. Likewise, the attribute of the interior vehicle operational mode can be decreased in response to the predetermined gesture 506 within the interior spatial location 502 as depicted in FIG. 5B or the predetermined gesture 604 within the interior spatial location 502 as depicted in FIG. 6B, both of which indicate decreasing the attribute. As the predetermined gestures 504, 506 are distinguishable from the predetermined gestures 602, 604, use of the different predetermined gestures could distinguish operation of various interior function control devices. For example, the predetermined gestures 504 (FIG. 5A) and 506 (FIG. 5B) could be assigned to a first interior function control device (e.g., interior lighting), while the predetermined gestures 602 (FIG. 6A) and 604 (FIG. 6B) could be assigned to a second interior function control device (e.g., an audio system).

After the activation signals are provided 316, 318, 319 to appropriate ones of the interior actuators 232, 234, 236, processing returns to continue processing detector signals 304. If no predetermined gesture is detected in an interior spatial location 308, processing determines if a predetermined gesture, including a predetermined item, is detected 310 in a validated exterior spatial location adjacent to the vehicle 100. If no predetermined gesture is detected in such validated exterior spatial location 310, processing returns to continue processing detector signals 304.

When a predetermined gesture is detected 310 in a validated exterior spatial location adjacent to the vehicle 100, the controller 220 determines the current operational mode 320. Then the controller 220 retrieves 321 unique information from the memory 224 and compares the predetermined gesture to the item represented by the unique information 322. If the predetermined item is not detected 324, the controller 220 determines 326 whether a predetermined gesture, such as a predetermined time based gesture, is detected. If no predetermined gesture is detected in an exterior spatial location 326, processing returns to continue processing detector signals 304.

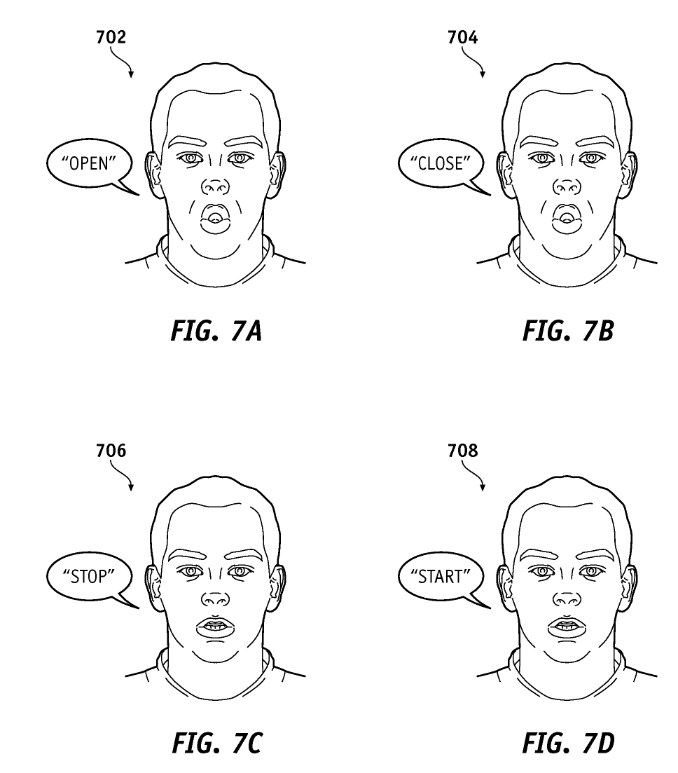

When a predetermined gesture is detected 326, the controller 220 generates 328 activation signals in response to the predetermined gesture, the current operational mode and location of the predetermined gesture and provides 330 the activation signals to actuators such as one or more of the vehicle closure panel actuators 260, after which the controller 220 operation returns to continue processing detector signals 304. FIG. 7, including FIGS. 7A, 7B, 7C and 7D, depict predetermined time based gestures comprising mouthing words which are recognizable by the controller 220. FIG. 7A depicts mouthing the word “OPEN” 702 to indicate, for example, opening a vehicle closure panel. FIG. 7B depicts mouthing the word “CLOSE” 702 to indicate, for example, closing a vehicle closure panel. FIG. 7C depicts mouthing the word “START” 702 to indicate, for example, starting the engine of the vehicle 100. And FIG. 7D depicts the mouthing the word “STOP” 702 to indicate, for example, stopping a current vehicle operational mode, such as stopping closure of a vehicle closure panel.

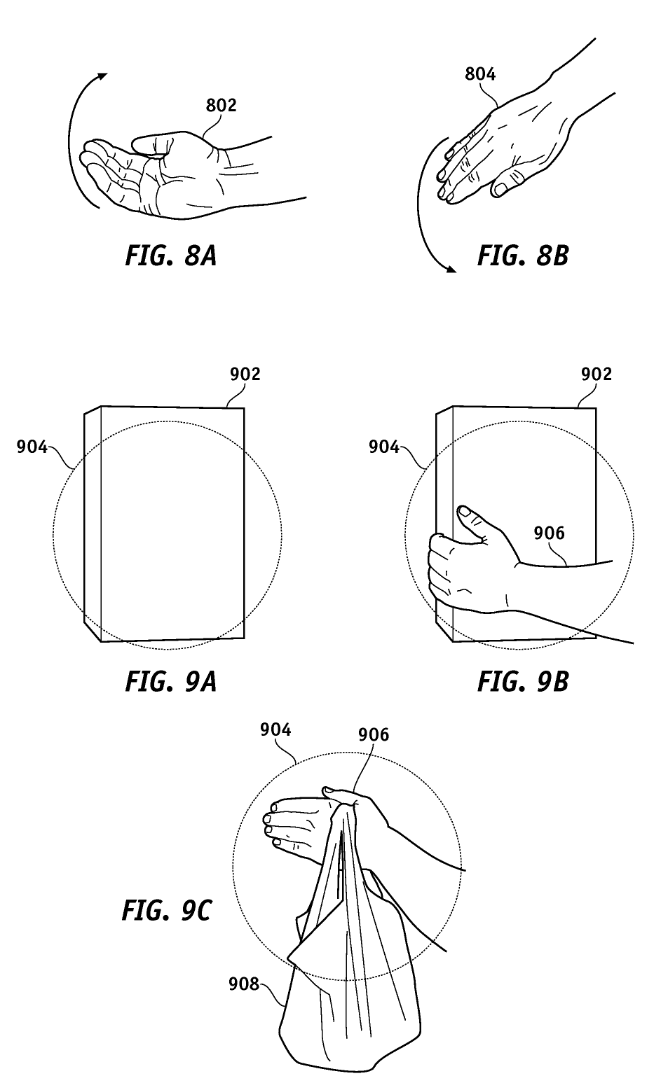

Referring to FIG. 8, including FIGS. 8A and 8B, manipulating an attribute of a vehicle operational mode could also be indicated by a predetermined time based gesture. Moving a hand in an upward motion 802 as depicted in FIG. 8A could be defined by the unique information stored in the memory 224 to indicate increasing an attribute of a vehicle operational mode, such as opening a folding top or a sunroof, while moving the hand in a downward motion 804 as depicted in FIG. 8B could be defined by the unique information stored in the memory 224 to indicate closing the folding top or the sunroof.

Referring back to FIG. 3, if a predetermined item is detected 332, the controller 220 generates 334 activation signals in response to the predetermined item, the current operational mode and location of the predetermined item and provides the activation signals to actuators such as one or more of the vehicle closure panel actuators 260, the controller 220 operation then returning to continue processing detector signals 304.

Referring to FIG. 9, including FIGS. 9A, 9B and 9C, predetermined items identifiable by the controller 220 based upon unique information stored in the memory 224 are depicted. In FIG. 9A, a box 902 can be a predetermined item which when identified by the controller 220 in a spatial location 904 adjacent to a vehicle closure panel could initiate opening of the vehicle closure panel. Likewise, in FIG. 9B, recognition of a hand 906 on the box 902 placed at the spatial location 904 could be utilized to initiate opening of the vehicle closure panel. In addition, identification of the hand 906 holding a bag 908 at the spatial location 904 could initiate opening of the vehicle closure panel.

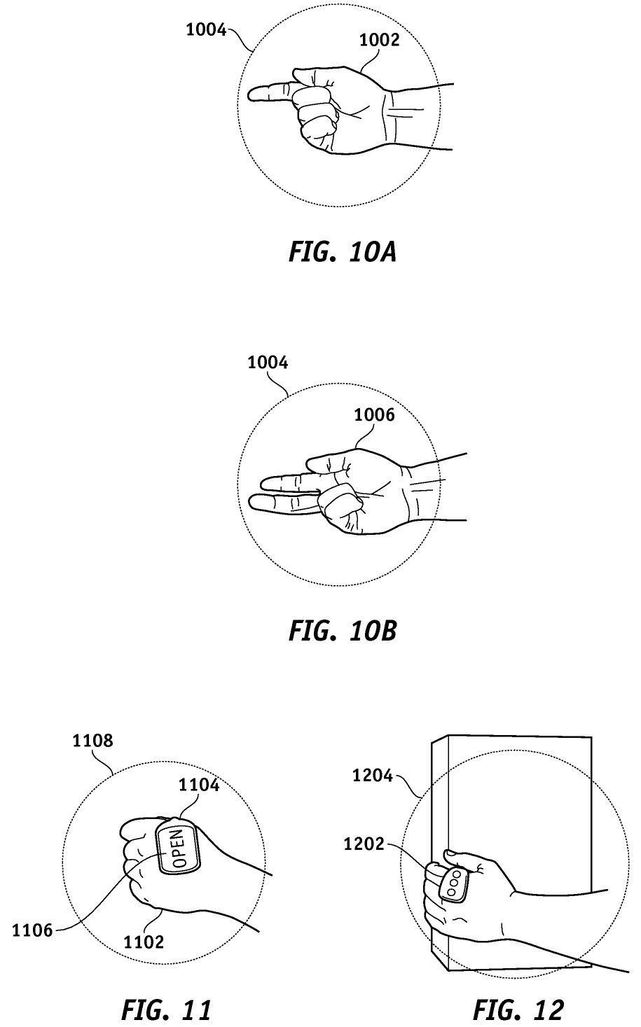

Referring to FIG. 10A, a first predetermined gesture 1002 at a predetermined spatial location 1004 could be defined to indicate activation of a first predefined operational mode, such as activating first personalized driver settings for the vehicle 100 (e.g., driver seat settings, mirror settings, power pedal settings, radio channel settings, etc.) when the predetermined spatial location 1004 is adjacent to the driver's door of the vehicle 100. Likewise, a second predetermined gesture 1006 at the predetermined spatial location 1004 as depicted in FIG. 10B could be defined to indicate activation of second personalized driver settings for the vehicle 100.

Also a vehicle authenticated text command could be a predetermined item. Referring to FIG. 11, a hand 1102 could be holding a key fob 1104 that includes a vehicle authenticated text command 1106, such as particular text (e.g., OPEN), written on the back of the key fob 1104. When the key fob 1104 with the vehicle authenticated text command 1106 is placed within a predetermined spatial location 1108, detection thereof would activate a predetermined operational mode of the vehicle 100 in accordance with the present embodiment. The vehicle authenticated text command 1106 could be identified in response to unique information stored in the memory 224 corresponding to the vehicle authenticated text command 1106, the vehicle authenticated text command 1106 validated (step 302) by the key fob 11104.

Also a vehicle authenticated device could be a predetermined item. Referring to FIG. 12, a key fob 1202 could be a vehicle authenticated device and when placed within a predetermined spatial location 1204, detection of the key fob 1202 could activate a predetermined operational mode of the vehicle 100. The key fob 1202 is identified as a vehicle authenticated device by unique information stored in the memory 224 corresponding to the key fob 1202.

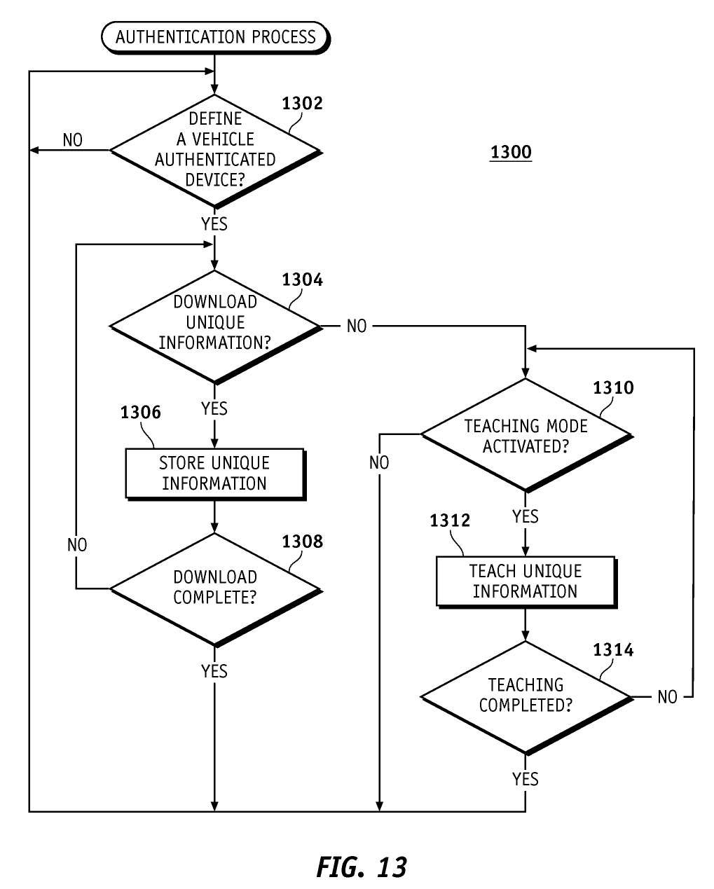

While certain vehicle authenticated devices could be defined by unique information stored in the memory 224 by the manufacturer, in accordance with the present embodiment, the controller 220 is also enabled to define any unique or personal item, such as a cellular telephone or a key chain ornament, as vehicle authenticated devices. For example, one owner's key chain ornament could activate first personalized driver settings for that person (e.g., seat, pedals, mirrors, radio channel, etc.) while another owner's key chain ornament could activate the personalized driver settings for that person. Referring to FIG. 13, a flowchart 1300 depicts an exemplary authentication process for defining a vehicle authenticated device. When the controller 220 determines 1302 that a vehicle authenticated device is to be defined, the controller 220 determines whether unique information to define the vehicle authenticated device is being downloaded 1304. The unique information could be included in a library downloaded to the controller 220 defining multiple vehicle authenticated devices or could be downloaded to the controller 220 as unique information corresponding to one or more vehicle authenticated devices. The download could be performed by wirelessly accessing the controller 220 via the wireless communication device 252 or using a storage device such as a USB drive and coupling the storage device to the controller 220.

As the unique information is downloaded 1204, the controller 220 stores 1306 the unique information in the memory 224. Processing continues downloading 1304 and storing 1306 until the controller determines 1308 that the download is complete. Processing then returns to await the next definition of a vehicle authenticated device 1302.

If unique information is not being downloaded 1304, processing determines if a vehicle authentication device teaching mode has been activated 13 10. If neither a download 1304 nor a teaching 1310 is detected, processing returns to await the next definition of a vehicle authenticated device 1302. When the controller determines that the vehicle authentication device teaching mode has been activated 1310 by, for example, a particular set of dashboard key presses, unique information corresponding to the vehicle authenticated device is taught 1312 to the controller 220. This can occur by the vehicle authenticated device being placed in a particular spatial location within view of a predetermined one of the detectors 210 for a predetermined time. Those skilled in the art will realize that numerous other teaching methodologies could be utilized in accordance with the present embodiment. When the teaching is completed 1314, processing returns to await the next definition of a vehicle authenticated device 1302.

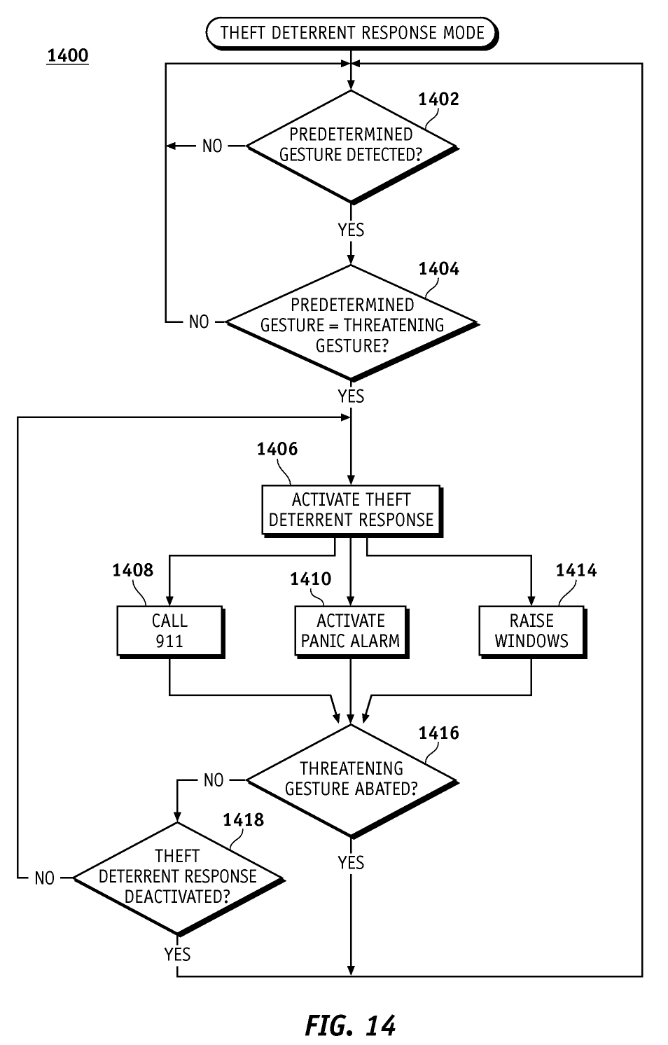

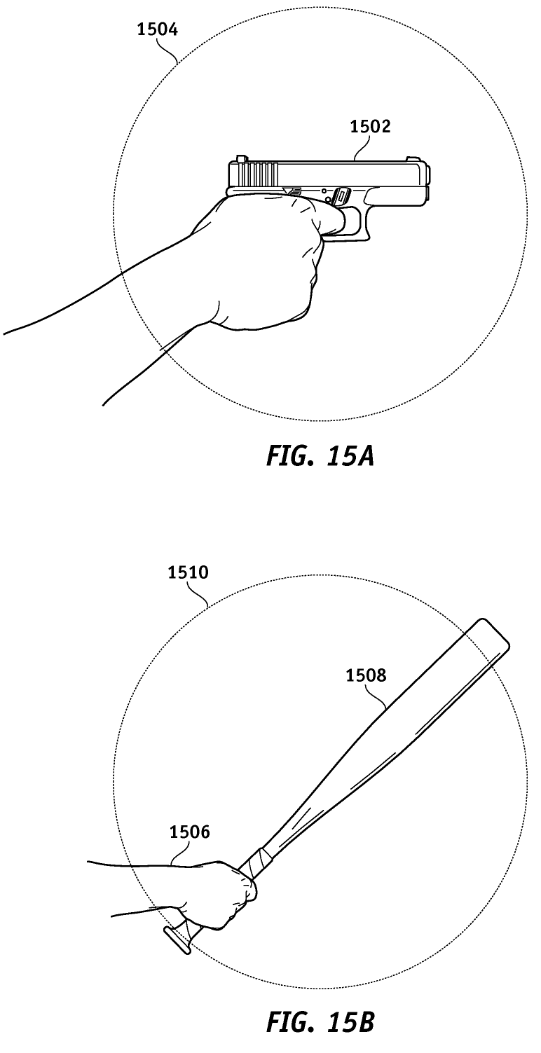

Referring to FIG. 14, a theft deterrent response mode in accordance with the present embodiment is depicted in flowchart 1400. When a predetermined gesture is detected 1402, the controller 220 determines whether the predetermined gesture is a threatening gesture 1404. The controller 220 determines whether the predetermined gesture is a threatening gesture in response to the current operational mode of the vehicle (e.g., is it parked and unattended or are occupants in the vehicle and it is stopped), the predetermined gesture (e.g., detecting a gun or an item to obtain access to a parked car), and the spatial location at which the predetermined gesture is detected (e.g., outside the driver's window). Referring to FIG. 15, including FIGS. 15A and 15B, examples of threatening gestures are depicted. In FIG. 15A, when a gun 1502 is detected in any spatial location 1504 adjacent to the exterior of the vehicle 100, the controller 220 identifies it as a threatening gesture. In FIG. 15B, the controller 220 can be programmed to identify a hand 1506 swinging an item 1508 such as a club or a baseball bat within a spatial location 1510 adjacent to the vehicle 100 as a threatening gesture. Those skilled in the art will realize that a library of threatening gestures can be stored in the memory 224 by a dealer or manufacturer for the vehicle 100.

Referring back to FIG. 14, when the controller 220 determines that the predetermined gesture is a threatening gesture 1404, a theft deterrent response is activated 1406. The theft deterrent response may include one or more of calling an emergency service provider (e.g., calling 911) 1408 by the controller sending activation signals to the 911 call actuator 248, activating a panic alarm 1410 involving activating lights and/or the audio alarm actuator 242, and raising the windows 1414 by the controller 220 sending activation signals to the raise window actuators 246. The controller 220 continues activating the theft deterrent response 1406 until either the threatening gesture is abated 1416 or the theft deterrent response is deactivated 1418 by an authorized and validated party.

Thus it can be seen that a method and vehicle for activation of various vehicle modes in response to gesture recognition has been provided. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for activation of a vehicle operational mode comprising the steps of:
visually monitoring one or more predetermined spatial locations interior to or adjacent to a vehicle;
detecting a predetermined gesture within one of the one or more predetermined spatial locations; and
activating a predetermined vehicle operational mode in response to the predetermined gesture and a current vehicle operational mode.

2. The method in accordance with claim 1 wherein the step of detecting the predetermined gesture comprises the step of detecting a threatening gesture, and wherein the step of activating the predetermined vehicle operational mode comprises the step of activating a theft deterrent response mode in response to the threatening gesture and the current vehicle operational mode.

3. The method in accordance with claim 2 wherein the step of activating the theft deterrent response mode comprises the step of activating one or more theft deterrent actions selected from the group of theft deterrent actions comprising activating an audio panic alarm, placing a call to an emergency service provider, and raising windows of the vehicle.

4. The method in accordance with claim 1 wherein the step of visually monitoring the one or more predetermined spatial locations comprises the step of visually monitoring one or more predetermined interior spatial locations within the vehicle, and wherein the step of activating the predetermined vehicle operational mode comprises the step of manipulating an attribute of one or more interior vehicle operational modes selected from the group of attributes comprising an audio system volume, an interior light brightness, and an interior temperature control.

5. The method in accordance with claim 4 wherein the step of detecting the predetermined gesture comprises the step of detecting a predetermined time based gesture, and wherein the step of manipulating the attribute of one or more interior vehicle operational modes comprises the step of increasing the attribute of the one or more interior vehicle operational modes in response to detecting a body part moving in a first predetermined direction, and wherein the step of manipulating the attribute of the one or more interior vehicle operational modes comprises the step of decreasing the attribute of the one or more interior vehicle operational modes in response to detecting the body part moving in a second predetermined direction.

6. The method in accordance with claim 1 wherein the step of detecting the predetermined gesture comprises the step of detecting a predetermined item within one of one or more predetermined exterior spatial locations, the item comprising a device or body part selected from the group of devices and body parts comprising a hand, a body part other than the hand, a vehicle authenticated device, a box, a bag, and a text command on a vehicle authenticated device.

7. The method in accordance with claim 6 further comprising the step of authenticating the vehicle authenticated device by storing unique information associated with the vehicle authenticated device, and wherein the step of detecting the predetermined item comprises the steps of:
detecting an item within the one of the one or more predetermined exterior spatial locations;
comparing the item to the stored unique information; and
determining that the vehicle authenticated device has been detected in response to information detected on the item corresponding to the stored unique information.

8. The method in accordance with claim 7 wherein the authentication step comprises one or more steps selected from the steps of storing a library of the unique information, downloading the unique information, and teaching the unique information.

9. The method in accordance with claim 1 wherein the step of activating the predetermined vehicle operational mode comprises the step of activating the predetermined vehicle operational mode in response to the predetermined gesture, the current vehicle operational mode, and a user validation.

10. The method in accordance with claim 1 wherein the step of activating the predetermined vehicle operational mode comprises the step of activating the predetermined vehicle operational mode corresponding to the one or more predetermined spatial locations in response to the predetermined gesture and the current vehicle operational mode.

11. The method in accordance with claim 10 wherein the step of detecting the predetermined gesture comprises the step of detecting a predetermined time based gesture within one of the one or more predetermined spatial locations, and wherein the step of activating the predetermined vehicle operational mode corresponding to the one or more predetermined spatial locations comprises the step of activating the predetermined vehicle operational mode corresponding to the one or more predetermined spatial locations in response to a movement of the predetermined time based gesture and the current vehicle operational mode.

12. The method in accordance with claim 11 wherein the movement of the predetermined time based gesture comprises mouthing a word.

13. A device for activation of an operational mode comprising:
one or more detectors for visually monitoring one or more predetermined spatial locations, each of the one or more detectors corresponding to one of the one or more predetermined spatial locations; and
a controller coupled to the one or more detectors and activating a predetermined operational mode in response to a current operational mode and a predetermined gesture detected within one of the one or more predetermined spatial locations.

14. The device in accordance with claim 13 further comprising one or more operational mode actuators, wherein the controller generates an activation signal in response to the current operational mode and the predetermined gesture, the controller activating the predetermined operational mode by providing the activation signal to at least one of the one or more operational mode actuators, the at least one of the one or more operational mode actuators selected by the controller in response to the current operational mode, the predetermined gesture, and the one of the one or more predetermined spatial locations in which the predetermined gesture is detected.

15. The device in accordance with claim 13 wherein the controller activates the predetermined operational mode in response to the current operational mode and a predetermined time based gesture detected within the one of the one or more predetermined spatial locations.

16. The device in accordance with claim 13 further comprising a storage device for storing unique information associated with the predetermined gesture, wherein the controller is coupled to the storage device and activates the predetermined operational mode in response to the current operational mode, the unique information, and the predetermined gesture.

17. A vehicle comprising:
one or more detectors for visually monitoring one or more predetermined spatial locations interior to the vehicle and adjacent to an exterior of the vehicle, each of the one or more detectors corresponding to one of the one or more predetermined spatial locations;
one or more operational mode actuators for activating a vehicle operational mode; and
a controller coupled to the one or more detectors and the one or more operational mode actuators, wherein the controller generates an activation signal in response to a current operational mode of the vehicle and a predetermined gesture detected by one of the one or more detectors, the controller providing the activation signal to at least one of the one or more operational mode actuators, the at least one of the one or more operational mode actuators selected by the controller in response to the current operational mode, the predetermined gesture, and the one of the one or more predetermined spatial locations in which the predetermined gesture is detected.

18. The vehicle in accordance with claim 17 wherein the controller generates the activation signal in response to the current operational mode and a vehicle authenticated device detected by one of the one or more detectors.

19. The vehicle in accordance with claim 17 wherein the one or more operational mode actuators comprise a closure panel actuator selected from the group of closure panel actuators comprising a vertically-hinged liftglass actuator, a horizontally-hinged liftglass actuator, a drop gate actuator, a lift gate actuator, a side door actuator, a sliding door actuator, a swing door actuator, a sunroof actuator, a folding top actuator, and a power tonnaeau cover actuator.

20. The vehicle in accordance with claim 19 wherein the controller generates a vehicle closure panel activation signal in response to the current operational mode and the predetermined gesture, the vehicle closure panel activation signal comprising the activation signal selected from the group of activation signals comprising a vehicle closure panel open signal, a vehicle closure panel close signal, and a vehicle closure panel stop signal.
